(19) United States
(12) Patent Application Publication
(10) Pub. No.: US 2006/0292413 A1
(43) Pub. Date: Dec. 28, 2006

(54) Fuel cell and method for producing same

(76) Inventor: Masaki Takaoka, Kyoto-shi (JP)

Correspondence Address: HAMRE, SCHUMANN, MUELLER & LARSON, P.C., P.O. BOX 2902, MINNEAPOLIS, MN, 55402-0902, US

(21) Appl. No.: 10/570,802

(22) PCT Filed: Sep. 10, 2004
(86) PCT No.: PCT/JP04/13564

§ 371 Date: Mar. 6, 2006

(30) Foreign Application Priority Data
Sep. 12, 2003 (JP) 2003-320968

(51) Int. Cl. H01M 8/10; B05D 5/12

(52) U.S. Cl. 429/30; 429/33; 427/115

(57) ABSTRACT

An aim of the invention is to provide a stable fuel cell having a high mechanical strength and a high reliability. Another aim of the invention is to provide a fuel cell which can be easily produced.

The fuel cell comprises a porous electrically-conductive material (13) as a substrate, a protonically-conductive membrane (16) formed on the porous electrically-conductive material (13) made of a mesoporous thin film comprising as a main component a crosslinked structure having a metal-oxygen skeleton having an acid group connected to at least a part thereof and having pores periodically aligned therein and a porous electrically-conductive material layer (17) formed on the protonically-conductive membrane.

### TECHNICAL FIELD

The present invention relates to a fuel cell and a method for producing same.

### BACKGROUND ART

In recent years, fuel cells have been noted as a next-generation electricity-generating apparatus which can make contributions to the solution to environmental problems and energy problems that are socially great assignments because they exhibit a high electricity- generating efficiency and excellent environmental characteristics.

Fuel cells are normally classified into several types by the kind of electrolyte. Among these types of fuel cells, direct methanol fuel cell (hereinafter referred to as “DMFC”) which directly receives methanol as a liquid fuel to cause electrochemical reaction by which it can work without using any reformer.

DMFC can use a liquid fuel having a high energy density and thus requires no reformer. Therefore, DMFC provides a compact system. Accordingly, DMFC has been noted particularly as an electric supply for portable apparatus substituting for lithium ion battery.

In DMFC, the following electrochemical reaction occurs to cause methanol to react directly with water on the anode and produce water on the cathode.

Anode: CH₃OH+H₂O→CO₂+6H⁺+6e⁻

Cathode: 6H⁺+2/3O₂+6e⁻→3H₂O

Herein, the protonically-conductive membrane acts to transmit proton produced on the anode to the cathode. The movement of proton occurs in competition with the flow of electron. In order to obtain a high output, i.e., high current density, it is necessary that the protonic conduction be conducted in a sufficient amount at a high rate. Accordingly, the performance of the protonically-conductive membrane greatly governs the performance of DMFC. Further, the protonically-conductive membrane not only plays a role in the conduction of proton but also acts as an insulating film for electrically insulating anode and cathode from each other as well as a fuel barrier for preventing the fuel supplied into the anode from leaking to the cathode.

As a high performance protonically-conductive membrane there has been heretofore used a fluororesin such as perfluorocarbonsulfonic acid polymer (Nafion®) (Patent Reference 1).

In such a protonically-conductive membrane, some sulfonic acid groups are agglomerated to form a reverse micelle structure. Therefore, such a protonically- conductive membrane is disadvantageous in that it can easily swell to cause methanol crossover as diagrammatically shown in the structure of perfluorocarbonsulfonic acid polymer before and during operation in FIG. 8. In other words, a protonically-conductive channel 103 is formed in a reverse micelle structure formed by a sulfonic acid group 102 connected to a perfluoro chain 101.

As can be seen in the comparison of the left portion with the right portion of FIG. 8, such a fluororesin membrane is disadvantageous in that swelling easily causes methanol crossover and change of the protonically-conductive structure in the membrane. Thus, methanol cannot be made sufficient use of, making it impossible to cause stable electrode reaction. As a result, the electricity generating efficiency is not sufficient.

It is also disadvantageous in that the repetition of swelling can easily cause deterioration of mechanical strength.

(Patent Reference 1) JP-A-7-90111

### DISCLOSURE OF THE INVENTION

The invention has been worked out under these circumstances. An aim of the invention is to provide a fuel cell having a high mechanical strength and a high efficiency which stays stable over an extended period of time.

The invention also provides a fuel cell which can be easily produced.

Thus, the fuel cell of the invention comprises a porous electrically-conductive material as a substrate, a protonically-conductive membrane formed on the porous electrically-conductive material made of a mesoporous thin film comprising as a main component a crosslinked structure having a metal-oxygen skeleton having an acid group connected to at least a part thereof and having pores periodically aligned therein and a porous electrically-conductive material layer formed on the protonically-conductive membrane.

In this arrangement, the protonically-conductive membrane is formed by a crosslinked structure having a rigid metal-oxygen skeleton. Thus, the skeleton structure itself is rigid. Accordingly, the protonically-conductive membrane can keep its pore diameter constant without swelling. Thus, crossover of methanol can be eliminated. As a result, a fuel cell having a high reliability can be provided. The porous electrically-conductive material as a substrate and the porous electrically-conductive material layer formed on the protonically-conductive membrane act as electrode. Since these layers can be integrally formed by a film-forming process rather than a bonding process, they can be easily mounted and exhibit an excellent adhesion.

The invention also concerns the aforementioned fuel cell wherein the crosslinked structure is formed by a silicon-oxygen bond. In this arrangement, a rigider skeleton structure can be obtained to provide a structure with a higher reliability.

The invention further concerns the aforementioned fuel cell wherein the mesoporous thin film has a thickness of 10 μm or less. In this arrangement, the protonic conduction distance can be reduced, making it possible to substantially raise the amount of protonic conduction. As a result, a fuel cell having a high efficiency can be obtained.

The invention further concerns the aforementioned fuel cell wherein the porous electrically-conductive material is a porous silicon layer formed by the anodization of silicon.

In this arrangement, an ordinary silicon process can be used to form the porous electrically-conductive material easily.

The invention further concerns the aforementioned fuel cell wherein an acid group is connected to the interior of the pores.

In this arrangement, the protonic conductivity can be further raised, making it possible to provide a fuel cell having excellent output properties.

The method for producing a fuel cell of the invention comprises a step of forming a substrate at least the surface of which is a porous electrically-conductive material, a step of forming a protonically-conductive membrane made of a mesoporous thin film comprising as a main component a crosslinked structure having a metal-oxygen skeleton having an acid group connected to at least a part thereof and having pores periodically aligned therein on the porous electrically-conductive material and a step of forming a porous electrically-conductive material layer on the protonically-conductive membrane.

In accordance with this method, an ordinary semiconductor process can be used to form a fuel cell having a high reliability easily at a good working efficiency.

The invention further concerns the aforementioned method for producing a fuel cell wherein the step of forming the substrate involves a step of anodizing the surface of a silicon substrate to form a porous silicon layer thereon.

In this manner, the silicon substrate is rendered permeable to methanol on the porous silicon layer side thereof. Thus, an electrode having a good fuel permeability can be formed by an ordinary silicon process.

The invention further concerns the aforementioned method for producing a fuel cell wherein the anodization step is preceded by a step of selectively etching the fuel cell forming region to a desired thickness.

In this manner, the thickness of the silicon substrate can be reduced to a value at which the silicon substrate can be fairly anodized all over the layer, making it possible to form a porous layer free of dispersion. At the same time, the anodization step requires a shorter time. The desired thickness of the silicon substrate thus etched is determined by the etching conditions. Thus, an electrode formed by a porous silicon layer having uniform thickness and properties can be formed at a good working efficiency.

The invention concerns the aforementioned method for producing a fuel cell wherein the step of forming a porous silicon layer is followed by a step of etching the silicon substrate on the back side thereof so that the porous silicon layer is reached to form a thin film.

In accordance with this method, the anodization step is followed by the reduction of the thickness of the silicon substrate. Thus, the area left insufficiently oxidized or the damaged surface may be merely etched away, making it possible to form an electrode formed by a porous silicon layer having a high reliability at a good working efficiency.

The invention further concerns the aforementioned method for producing a fuel cell wherein there comprises a step of introducing an acid group in the pores.

In accordance with this method, a silicon-oxygen structure can be exposed to an oxidizing atmosphere such as sulfonic acid to introduce an acid group in the pores at a good working efficiency.

The invention further concerns the aforementioned method for producing a fuel cell wherein there comprises a step of introducing a particulate catalyst into the surface of the crosslinked structure.

In accordance with this method, a particulate catalyst can be stably supported on the surface of the crosslinked structure.

The invention further concerns the aforementioned method for producing a fuel cell wherein there comprises a step of forming a first catalyst layer on the surface of the porous silicon layer, a step of forming on the surface of the catalyst layer a protonically-conductive membrane made of a mesoporous thin film comprising a crosslinked structure having an inorganic skeleton and having pores aligned periodically therein and an acid group connected thereto and a step of forming a second catalyst layer on the protonically-conductive membrane.

In this manner, a fuel cell can be easily produced at a good working efficiency.

Further, the porous electrically-conductive material can be formed by a porous carbon to have a good electric conductivity as well as a good adhesion to the oxygen-silicon crosslinked structure.

Moreover, in the invention, the step of forming a protonically-conductive membrane may involve a step of preparing a precursor solution containing water, ethanol, hydrochloric acid, a surface active agent and TEOS, a step of spreading the precursor solution over a substrate, a step of removing the surface active agent to form a crosslinked structure having a silicon-oxygen structure, a step of silylating the crosslinked structure to form a crosslinked structure having a mercapto group in the silicon-oxygen structure and a step of oxidizing the mercapto group in the crosslinked structure to form a crosslinked structure having a sulfonic acid group.

In accordance with this method, the composition ratio of the precursor solution and the silylation and oxidization conditions can be controlled to control the porosity and the formation of the protonically-conductive channel. In this manner, the methanol and proton permeability of the membrane can be controlled.

Further, the step of removing the surface active agent may be preceded by a step of exposing the silicon substrate to MPTMS vapor to silylate the silicon substrate.

In this manner, an acid group can be introduced into micropores as well, making it possible to form a protonically-conductive membrane having a high protonic conductivity.

Moreover, the step of removing the surface active agent may involve a step of extracting the surface active agent with an acid.

In this manner, the surface active agent can be extracted without passing through a high temperature step, making it possible to extract the surface active agent without releasing the acid group introduced at the silylation step.

The invention further concerns the aforementioned method for producing a fuel cell wherein the step of removing a surface active agent involves a calcining step.

Calcination causes the surface active agent to be fairly removed, making it possible to form a crosslinked structure containing a silicon-oxygen structure.

The invention further concerns the aforementioned method for producing a fuel cell wherein the silylation step involves a step of exposing the silicon substrate to a mercaptopropyl trimethoxy silane (MPTMS) vapor. In this manner, a crosslinked structure having a mercapto group connected thereto can be easily formed.

The invention further concerns the aforementioned method for producing a fuel cell wherein the step of supplying a precursor solution to the substrate involves a step of dipping the substrate in the precursor solution and withdrawing the substrate from the precursor solution at a desired rate.

Preferably, the step of supplying a precursor solution to the substrate involves a step of repeatedly and sequentially spreading the precursor solution over the substrate.

More preferably, the step of supplying a precursor solution to the substrate involves a rotary spreading step of dropping the precursor solution onto the substrate and rotating the substrate.

In accordance with the aforementioned method, the thickness of the layer or the pore diameter can be adjusted to easily adjust the capability of inhibiting permeation of methanol and the protonic conductivity, making it possible to form a high quality fuel cell with a good productivity.

Further, in accordance with the method of the invention, the silica derivative is selected, making it possible to further adjust the porosity.

As mentioned above, in accordance with the invention, MEA of fuel cell having a protonically- conductive membrane formed by a crosslinked structure having a rigid metal-oxygen skeleton can be integrally formed, making it possible to provide a stable fuel cell having a high mechanical strength and a high efficiency.

Moreover, in accordance with the invention, a fuel cell can be easily provided at a good working efficiency by an ordinary semiconductor process.

### BRIEF DESCRIPTION OF THE DRAWINGS

FIG. 1 is a diagrammatic view illustrating the configuration of the protonically-conductive membrane of a fuel cell formed by an embodiment of implementation of the invention;

FIG. 2 is an enlarged view of an essential part of the protonically-conductive membrane;

FIGS. 3A to 3F are the diagrams illustrating a process for the production of a fuel cell comprising a protonically-conductive membrane according to Embodiment 1 of implementation of the invention;

FIG. 4 is a flow chart illustrating a process for the formation of the protonically-conductive membrane according to Embodiment 1 of implementation of the invention;

FIG. 5 is a configurational view illustrating the electrophoresis in Embodiment 1 of implementation of the invention;

FIG. 6 is a flow chart illustrating a process for the formation of a protonically-conductive membrane according to Embodiment 2 of implementation of the invention;

FIGS. 7A to 7G are the diagrams illustrating a process for the production of a fuel cell comprising a protonically-conductive membrane according to Embodiment 3 of implementation of the invention; and

FIGS. 8A and 8B are the diagrams illustrating swelling of a related art protonically-conductive membrane.

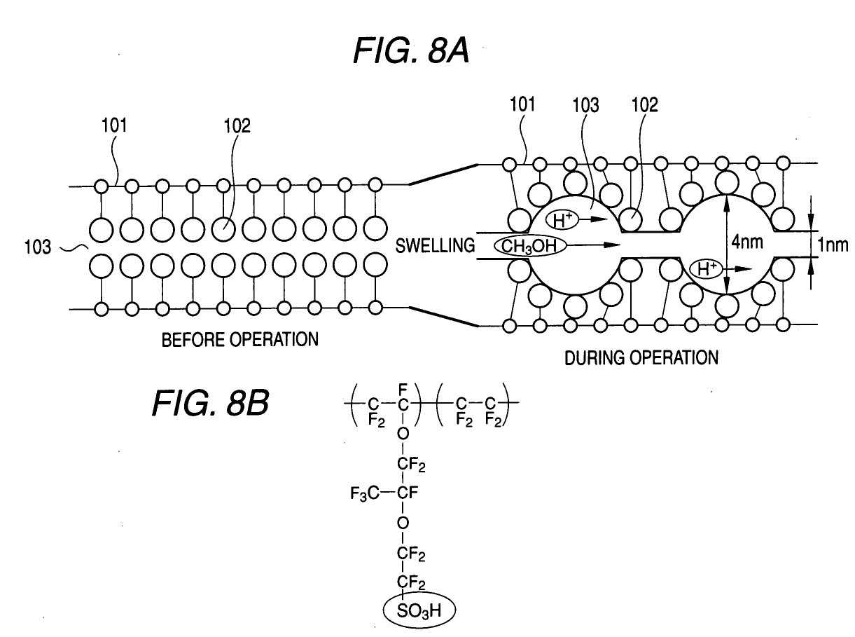

In these drawings, the reference numeral 1 denotes a perfluoro group, the reference numeral denotes a sulfonic acid group, and the reference numeral 3 denotes a protonically-conductive channel.

### BEST MODE FOR CARRYING OUT THE INVENTION

An embodiment of the fuel cell according to the invention will be described in detail in connection with the attached drawings.

### Embodiment 1

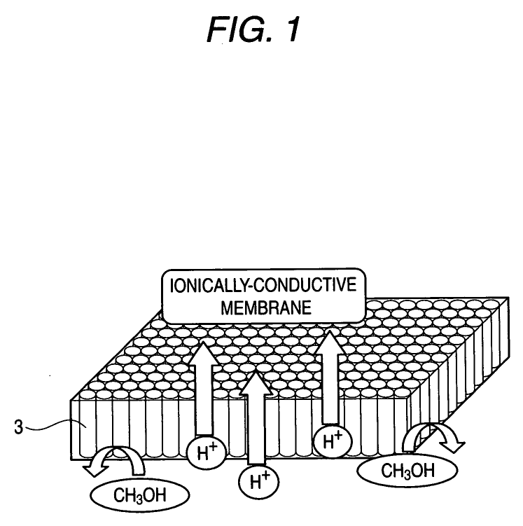

As diagrammatically shown in FIG. 1, the protonically-conductive membrane to be incorporated in the fuel cell according to the present embodiment is made of a mesoporous thin film comprising as a main component a crosslinked structure having a metal-oxygen skeleton having an acid group connected to at least a part thereof and having pores periodically aligned therein to form a

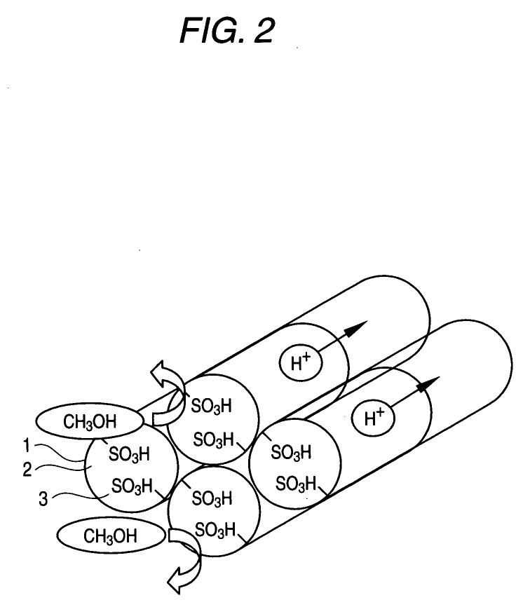

FIG. 2 is an enlarged view of an essential part of FIG. 1. A columnar pore which forms a protonically- conductive channel 3 has a sulfonic acid group incorporated therein to have an enhanced protonic conductivity.

A method for forming the electrode-electrolyte assembly (MEA) of the fuel cell will be described hereinafter.

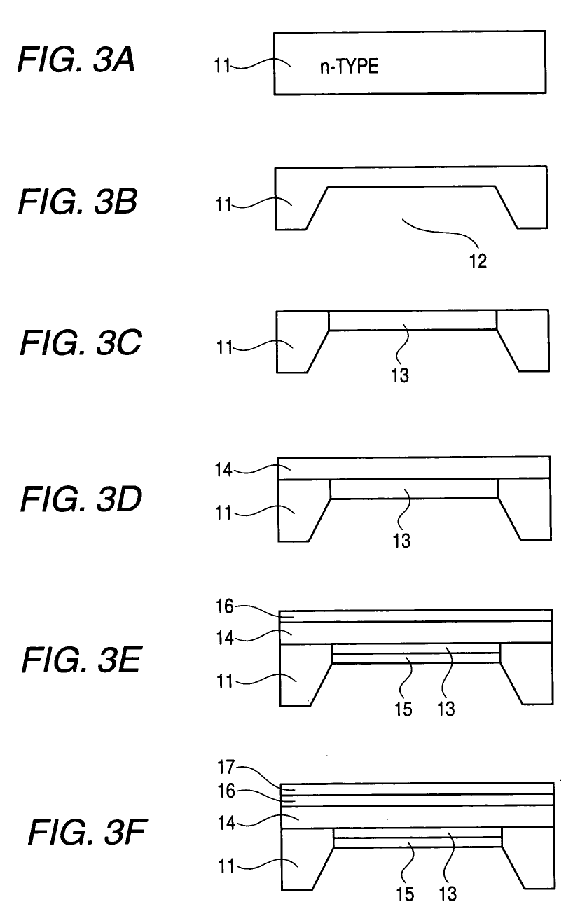

FIGS. 3A to 3G each depicts a procedure of forming MEA.

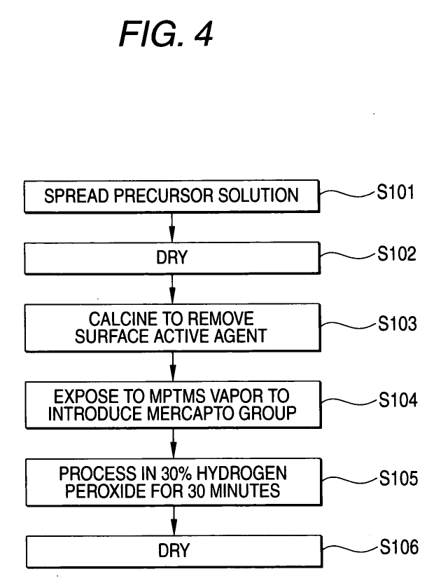

FIG. 4 is a flow chart illustrating a procedure of forming a protonically-conductive membrane.

Firstly, as shown in FIG. 3A, an n-type silicon substrate 11 having a (100) plane having a specific resistance of 5×10¹⁸ cm⁻³ as a main plane is prepared.

Subsequently, as shown in FIG. 3B, a resist pattern having an opening in a cell forming region is formed on the back side of the silicon substrate 11. The silicon substrate 11 is then subjected to anisotropic etching with a 83° C. TMAH solution to a desired depth. In this manner, an opening 12 is formed for forming a thin portion.

Subsequently, as shown in FIG. FIG. 3C, the silicon substrate is anodized so that the entire silicon substrate 11 becomes a porous silicon 13 having a pore diameter of from 10 nm to 5 μm.

Subsequently, a mesoporous thin film (protonically-conductive membrane) having columnar pores aligned periodically and perpendicular to the surface of the silicon substrate is formed on the porous silica 13.

In some detail, a cationici cetyl trimethyl ammonium bromide (C16TAB: C₁₆H₃₃N⁺ (CH₃)₃Br) as a surface active agent, TEOS (tetraethoxysilane) as a silica derivative and hydrochloric acid (HCl) as an acid catalyst are dissolved in a mixture of H₂O (water) and Et-OH (alcohol), and then stirred in a mixing vessel to prepare a precursor solution. The molar ratio of these components in the precursor solution (H₂O Et-OH:HCl:C16TAB:TEOS) is 100:76:5:0.5:3. The mixed solution thus prepared is spread over the surface of the silicon substrate on which the porous silicon 13 has been formed using a spinner as shown in FIG. 3B (Step 101 in FIG. 4), and then dried at 90° C. for 5 minutes (Step 102 in FIG. 4) so that the silica derivative is subjected to hydrolytic polycondensation reaction to undergo polymerization (precrosslinking step). Thus, a periodic self-agglomerate of surface active agent is formed.

This self-agglomerate forms a rod-shaped micelle structure having a plurality of molecules C₁₆H₃₃N⁺ (CH₃)₃Br agglomerated. In this arrangement, as the percent agglomeration rises with the rise of concentration, the portion freed of methyl group becomes more hollow. Thus, a crosslinked structure having pores aligned therein is formed.

Subsequently, the self-agglomerate is washed with water, dried, and then heated/calcined in a 500° C. nitrogen atmosphere for 6hours (Step 103 in FIG. 4) so that the surface active agent in the matrix is fully thermally decomposed away to form a pure mesoporous thin film. The silicon substrate is then processed with a 180° C. MPTMS vapor for 4 hours (Step 104 in FIG. 4) to form a silicon- oxygen crosslinked structure having mercapto group connected thereto. Thereafter, the silicon substrate is subjected to heat treatment in a 30% hydrogen peroxide for 30 minutes (Step 105 in FIG. 4), and then dried (Step 106 in FIG. 4).

In this manner, a protonically-conductive membrane 14 is formed as shown in FIG. 3D. The protonically-conductive membrane 14 has columnar pores aligned along the thickness of the layer.

FIG. 2 is a configurational view illustrating a section of this structure. As can be seen in FIG. 2, columnar pores are formed. Further, a porous thin film having a skeleton structure containing a large number of pores is formed.

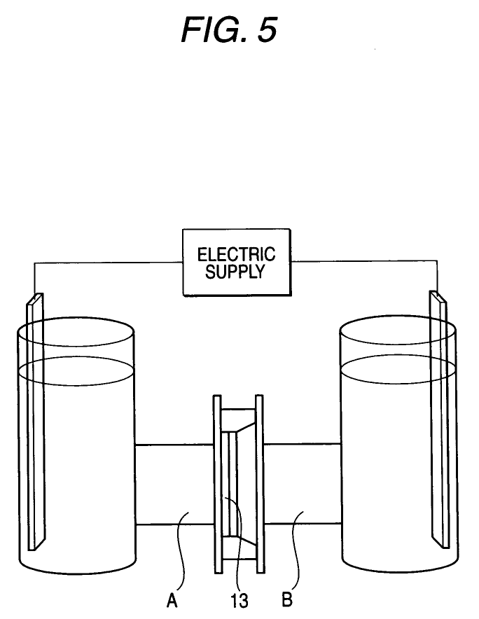

Thereafter, a carbon-supported platinum, a 5 wt-% Nafion® solution and ethanol are mixed, and then subjected to supersonic dispersion to prepare a suspension A. As shown in FIG. 5, a voltage is then applied to the system with the suspension A in contact with the back side of the porous silicon 13 and a 0.1 M aqueous solution of perchloric acid B provided on the other side to cause electrophoresis by which a catalyst layer 15 is formed. During this process, Nafion® in the suspension is attached to the surface of the porous silicon 13 to act as a dispersant. Thus, the catalyst layer 15 containing platinum is formed.

Subsequently, as shown in FIG. 3E, a catalyst layer 16 is similarly formed on the front surface of the protonically-conductive membrane 14.

Subsequently, as shown in FIG. 3F, an electrode layer 17 is formed.

In this manner, MEA is formed. A diffusion electrode (not shown) is then attached to this MEA to form a DMFC type fuel cell.

In this arrangement, the protonically-conductive membrane is formed by a silicon-oxygen crosslinked structure having columnar pores aligned regularly and thus has a high mechanical strength and undergoes no swelling. Further, since this protonically-conductive membrane undergoes no swelling, it undergoes little methanol crossover and exhibits a high efficiency and a high reliability.

By subjecting the silicon substrate to processing with TEOS vapor prior to calcination, the volumetric shrinkage during calcination can be eliminated to strengthen the silica skeleton, making it possible to further enhance the mechanical strength thereof.

While the present embodiment has been described with reference to the case where the protonically-conductive membrane is formed by an inorganic structure mainly composed of a crosslinked structure containing a silicon-oxygen bond, an organic- inorganic hybrid crosslinked structure containing an organic group in the silicon-oxygen skeleton may be used.

By covering the back side of MEA with a glass substrate or the like to form a fuel channel and forming a metal electrode on the surface of the electrode layer 17 on the front surface thereof, a fuel cell module can be formed.

While the present embodiment has been described with reference to the case where only MEA is formed by a silicon process, a continuous silicon process may be effected on a wafer level to form other portions, including a groove for fuel channel. The back side of the structure shown in FIG. 3F may be covered with a glass substrate or the like to form a fuel channel. A metal electrode may be then formed on the surface of the electrode layer 17 on the front surface of the structure. The structure may be then diced to form individual cells.

In this manner, a fuel cell module can be easily formed.

### Embodiment 2

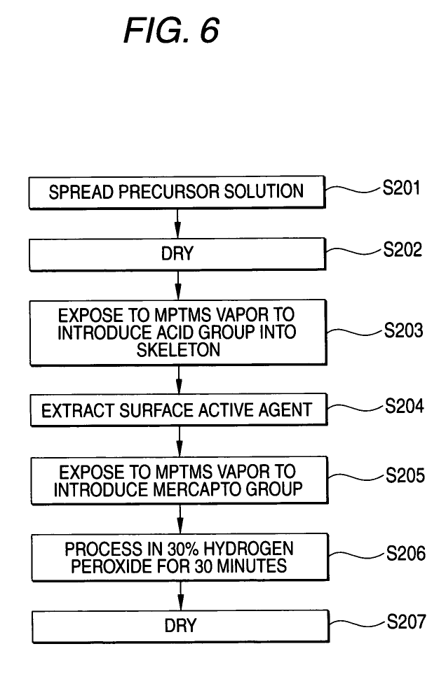

In Embodiment 1, silylation is effected after calcination. In the present embodiment, however, silylation is effected prior to extraction of surface active agent by calcination as shown in the flow chart of FIG. 6 to introduce an acid group (mercapto group) also into the silicon-oxygen skeleton so that the surface active agent can be subsequently extracted with hydrochloric acid.

As shown in the flow chart of FIG. 6, a cationici cetyl trimethyl ammonium bromide (C16TAB: C₁₆H₃₃N⁺ (CH₃)₃Br) as a surface active agent, TEOS (tetraethoxysilane) as a silica derivative and hydrochloric acid (HCl) as an acid catalyst are dissolved in a mixture of H₂O (water) and Et-OH (alcohol), and then stirred in a mixing vessel to prepare a precursor solution. The molar ratio of these components in the precursor solution (H₂O:Et-OH:HCl:C16TAB:TEOS) is 100:76:5:0.5:3. The mixed solution thus prepared is spread over the surface of the silicon substrate on which the porous silicon 13 has been formed using a spinner as shown in FIG. 3B (Step 201 in FIG. 6), and then dried at 90° C. for 5 minutes (Step 202 in FIG. 6) so that the silica derivative is subjected to hydrolytic polycondensation reaction to undergo polymerization (precrosslinking step). Thus, a periodic self-agglomerate of surface active agent is formed.

This self-agglomerate forms a rod-shaped micelle structure having a plurality of molecules C₁₆H₃₃N⁺ (CH₃)₃Br agglomerated. In this arrangement, as the percent agglomeration rises with the rise of concentration, the portion freed of methyl group becomes more hollow. Thus, a crosslinked structure having pores aligned therein is formed.

Subsequently, the self-agglomerate is exposed to MPTMS vapor so that an acid group is introduced also into the silicon-oxygen skeleton (Step 203 in FIG. 6), washed with water, dried, and then extracted with hydrochloric acid (Step 204 in FIG. 6) so that the surface active agent in the matrix is fully decomposed away to form a pure mesoporous thin film.

The silicon substrate is then again processed with a 180° C. MPTMS vapor for 4 hours (Step 205 in FIG. 6) to form a silicon-oxygen crosslinked structure having mercapto group connected thereto. Thereafter, the silicon substrate is subjected to heat treatment in a 30% hydrogen peroxide for 30 minutes (Step 206 in FIG. 6), and then dried (Step 207 in FIG. 6).

In this manner, in addition to the advantage of Embodiment 1, acid groups are introduced prior to the removal of the surface active agent, making it possible to incorporate more acid groups in the structure. Thus, a protonically-conductive membrane having a high reactivity can be obtained.

The formulation of the precursor solution is not limited to that of the present embodiment. The composition ratio of the surface active agent, the silica derivative and the acid catalyst are preferably from 0.01 to 0.1, from 0.01 to 0.5 and from 0 to 5 based on 100 of the solvent. The use of the precursor solution having such a formulation makes it possible to form a membrane having cylindrical pores.

While the present embodiment has been described with reference to the case where as the surface active agent there is used a cationic cetyl trimethyl ammonium bromide (CTAB: C₁₆H₃₃N⁺ (CH₃)₃Br), the invention is not limited thereto. It goes without saying that other surface active agents such as nonionic Pluronic HO—CH₂CH(CH₃)O)_{y}—CH₂CH₂)O)ₓ—H may be used.

However, when an alkali ion such as Na ion is used as a catalyst, it causes deterioration of semiconductor material. Therefore, a cationic surface active agent is preferably used. As a catalyst there is preferably used an acid catalyst. As such an acid catalyst there may be used nitric acid (HNO₃), sulfuric acid (H₂SO₄), phosphoric acid (H₃PO₄), H₄SO₄ or the like besides HCl.

The silica derivative is not limited to hydrogen silosesquioxane (HSQ) or methyl silosesquioxane (MSQ). Any silica derivative materials having a 4-membered or higher siloxane skeleton may be used.

While the present embodiment has been described with reference to the case where as a solvent there is used a mixture of water (H₂O) and alcohol, only water may be used.

While the present embodiment has been described with reference to the case where as a calcining atmosphere there is used a nitrogen atmosphere, calcination may be effected in vacuo or in the atmosphere. Preferably, the use of a forming gas composed of a mixture of nitrogen and hydrogen makes it possible to enhance the moisture resistance and hence reduce leakage current.

The mixing proportion of surface active agent, silica derivative, acid catalyst and solvent can be properly changed.

While the present embodiment has been described with reference to the case where the prepolymerization step is carried out by keeping the reaction mixture at a temperature of from 30° C. to 150° C. for 1 hour to 120 hours, the reaction temperature is preferably from 60° C. to 120° C., more preferably 90° C.

While the present embodiment has been described with reference to the case where the calcination step is effected at 500° C. for 6 hours, the calcination step may be effected at a temperature of from 250° C. to 500° C. for 1 to 8 hours, preferably from 350° C. to 450° C. for about 6 hours.

Even when the same processing is effected, different results are obtained from the case where a surface active agent is used to the case where no surface active agent is used. In other words, at the step of MPTMS processing (Step 203) effected prior to the removal of surface active agent, the silylating agent penetrates into and modifies the silica because the micropores have the surface active agent present therein. On the other hand, at the step of MPTMS processing (Step 205) effected after the removal of surface active agent, the silylating agent diffuses the pores and modifies the surface of the micropores.

### Embodiment 3

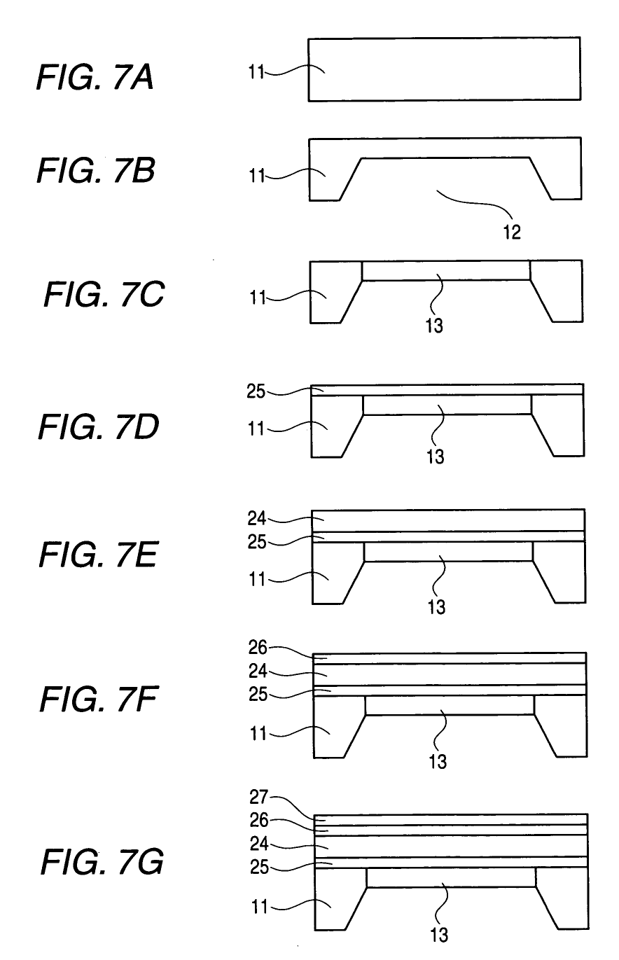

While Embodiment 1 has been described with reference to the case where the formation of the catalyst layer is carried out by electrophoresis, the formation of the catalyst layer may be carried out by plating in the present embodiment as shown in the flow sheet of FIGS. 7A to 7G.

As shown in FIGS. 7A to 7C, the processing is effected in the same manner as in Embodiment 1 until the step of reducing the thickness of the silicon substrate 11 to form a porous silicon 13.

Subsequently, as shown in FIG. 7D, plating is effected to form a catalyst layer 25 made of a metal containing platinum on the porous silicon 13.

Subsequently, as shown in FIG. 7E, a mesoporous thin film (protonically-conductive membrane) 24 having columnar pores aligned periodically and perpendicular to the surface of the silicon substrate is formed in the same manner as in Embodiment 1.

Subsequently, as shown in FIG. 7F, plating is effected to form a catalyst layer 26 made of a metal containing platinum on the protonically-conductive membrane 24.

As shown in FIG. 7G, a paste containing a particulate carbon is spread over the catalyst layer, and then calcined to form an electrode layer 27.

Thus, MEA is formed.

### Embodiment 4

While Embodiment 1 has been described with reference to the case where the formation of the mesoporous thin film is carried out by a spin coating method, the invention is not limited thereto. A dipping method may be used.

In some detail, a cationici cetyl trimethyl ammonium bromide (CTAB: C₁₆H₃₃N⁺ (CH₃)₃Br) as a surface active agent, hydrogen silosesquioxane (HSQ) as a silica derivative and hydrochloric acid (HCl) as an acid catalyst are dissolved in a mixture of H₂O and alcohol, and then stirred in a mixing vessel to prepare a precursor solution. The molar ratio of these components in the precursor solution (surface active agent:silica derivative:acid catalyst) is 0.5:0.01:2 based on 100 of the solvent. The silicon substrate 11 on which the porous silicon layer 13 has been formed is dipped in the mixed solution. The mixing vessel is then sealed. The silicon substrate 11 is then kept at a temperature of from 30° C. to 150° C. for 1 hour to 120 hours so that the silica derivative is subjected to hydrolytic polycondensation reaction to undergo polymerization (precrosslinking step). Thus, a periodic self-agglomerate of surface active agent is formed.

This self-agglomerate forms a rod-shaped micelle structure having a plurality of molecules C₁₆H₃₃N⁺ (CH₃)₃Br agglomerated. In this arrangement, as the percent agglomeration rises with the rise of concentration, the portion freed of methyl group becomes more hollow. Thus, acrosslinked structure having pores aligned therein is formed.

Subsequently, the silicon substrate is withdrawn from the mixed solution, washed with water, dried, and then heated/calcined in a 400° C. nitrogen atmosphere for 3 hours so that the surface active agent in the matrix is fully thermally decomposed away to form a pure mesoporous thin film.

### Embodiment 5

While Embodiment 1 has been described with reference to the case where the formation of the mesoporous thin film is carried out by a spin coating method, the invention is not limited thereto. A dip coating method may be used.

In some detail, the silicon substrate is allowed to descend perpendicular to the liquid level of the precursor solution prepared at a rate of from 1 mm/s to 10 m/s until it sinks in the solution, and then allowed to stand for 1 second to 1 hour.

After the lapse of a desired period of time, the silicon substrate is then allowed to ascend vertically at a rate of from 1 mm/s to 10 m/s until it is withdrawn from the solution.

Finally, the silicon substrate is calcined in the same manner as in Embodiment 1 so that the surface active agent in the matrix is fully thermally decomposed away to form a pure mesoporous thin film.

While the present embodiment has been described with reference to the case where a mesoporous thin film having columnar pores periodically aligned is used, the diameter and alignment of the pores are not limited to the present embodiment but may be changed.

As the catalyst there may be used Brij30 (C₁₂H₂₅ (OCH₂CH₂)₄OH) or the like besides C16TAB.

Further, the use of Pluronic F127 (trade name) as a surface active agent makes it possible to form a three-dimensional porous thin film.

While the present embodiment has been described with reference to a crosslinked structure having a silicon-oxygen bond, a metal-oxygen crosslinked structure such as titanium-oxygen crosslinked structure may be also used.

Moreover, as the acid group which is bonded to the silicon-oxygen crosslinked structure to cause protonic conduction there may be used phosphoric acid (H₃PO₄) or perchloric acid (HClO₄) besides sulfonic acid.

While the present invention has been described in detail and with reference to specific embodiments thereof, it will be apparent to one skilled in the art that various changes and modifications can be made therein without departing from the spirit and scope thereof.

The present application is based on Japanese Patent Application No. 2003-320968, filed on Sep. 12, 2003, the contents of which are hereby incorporated by reference.

### INDUSTRIAL APPLICABILITY

As mentioned above, the invention can be effectively applied to DMFC type fuel cell and thus can be effectively used as an electric supply for small-sized apparatus such as cellular phone and note personal computer.

1. A fuel cell comprising a porous electrically-conductive material as a substrate, a protonically-conductive membrane formed on the porous electrically-conductive material made of a mesoporous thin film comprising as a main component a crosslinked structure having a metal-oxygen skeleton having an acid group connected to at least a part thereof and having pores periodically aligned therein and a porous electrically-conductive material layer formed on the protonically-conductive membrane.

2. The fuel cell as defined in claim 1, wherein the crosslinked structure is formed by a silicon-oxygen bond.

3. The fuel cell as defined in claim 1, wherein the mesoporous thin film has a thickness of 10 μm or less.

4. The fuel cell as defined in any claim 1, wherein the porous electrically-conductive material is a porous silicon layer formed by the anodization of silicon.

5. A method for producing a fuel cell comprising:
A step of forming a substrate at least the surface of which is a porous electrically-conductive material;
A step of forming a protonically-conductive membrane made of a mesoporous thin film comprising as a main component a crosslinked structure having a metal-oxygen skeleton having an acid group connected to at least a part thereof and having pores periodically aligned therein on the porous electrically-conductive material; and
A step of forming a porous electrically-conductive material layer on the protonically-conductive membrane.

6. The method for producing a fuel cell as defined in claim 5, wherein the step of forming the substrate involves a step of anodizing the surface of a silicon substrate to form a porous silicon layer thereon.

7. The method for producing a fuel cell as defined in claim 6, wherein the anodization step is preceded by a step of selectively etching the fuel cell forming region to a desired thickness.

8. The method for producing a fuel cell as defined in claim 6, wherein the step of forming a porous silicon layer is followed by a step of etching the silicon substrate on the back side thereof so that the porous silicon layer is reached to form a thin film.
